(19) United States
(12) Patent Application Publication
(10) Pub. No.: US 2012/0197764 A1
(43) Pub. Date: Aug. 2, 2012

(54) METHOD AND PROCESS OF USING METADATA ASSOCIATED WITH A DIGITAL MEDIA TO SEARCH FOR LOCAL INVENTORY

(75) Inventors: Frank Anthony Nuzzi, Pflugerville, TX (US); James Brett Sowder, Austin, TX (US)

(73) Assignee: eBay Inc., San Jose, CA (US)

(21) Appl. No.: 13/019,918

(22) Filed: Feb. 2, 2011

(51) Int. Cl. G06Q 30/00

(52) U.S. Cl. 705/27.1

(57) ABSTRACT

In various exemplary embodiments, a method of selecting and retrieving information related to selectable items in a dynamic digital event (e.g., a movie) is presented. Each of the selectable items is available for purchase by an end-user. The method includes preparing the digital event for presentation on an electronic device of the end-user. Preparing the digital event includes generating tags for each of the selectable items within the digital event and adding metadata for each item. The metadata includes a description for each item. An indication is displayed to the end-user that one or more of the selectable items are present within at least a portion of the digital event. A determination is made whether the end-user has selected at least one item. Based on a determination that the end-user has selected at least one item, the metadata associated with the at least one item is displayed to the end-user.

### TECHNICAL FIELD

The present application relates generally to the field of computer technology and, in a specific exemplary embodiment, to a system and method of allowing an end-user to select items from a digital event, such as, for example, a movie, for possible purchase.

### BACKGROUND

Consumers are becoming increasingly fascinated with articles of clothing and other products they see in movies. Commensurate with this fascination, the consumers frequently wonder where they can obtain such items. Moreover, manufacturers are increasingly attempting to sell their wares with various product placements in movies, television productions, and video games. Accordingly, consumers are increasingly using on-line services and other electronic marketing resources on the Internet in an attempt to find these items. Although various on-line services offer convenience to consumers, the services still are unable to provide guidance in terms of matching an exact item the consumer sees in a movie to an actual item available for sale.

### BRIEF DESCRIPTION OF DRAWINGS

Various ones of the appended drawings merely illustrate exemplary embodiments of the inventive subject matter presented herein. Therefore, the appended cannot be considered as limiting a scope of the inventive subject matter.

FIG. 1 shows a simplified high-level diagram depicting an environment according to various exemplary embodiments for selecting items and using metadata associated with a digital event to search for inventory;

FIG. 2 is a block diagram illustrating an exemplary embodiment of a high-level client-server-based network architecture diagram depicting a system used to search for inventory;

FIG. 3 is a block diagram illustrating an exemplary embodiment of various modules of the network architecture of FIG. 2;

FIG. 4. is an exemplary method of inserting metadata associated with items into a digital event;

FIG. 5 is an exemplary method of selecting items associated with a digital event;

FIG. 6 is an exemplary diagram of a display of an electronic device illustrating various pop-up menus that can occur during the viewing of a digital event;

FIG. 7 shows an alternative embodiment of a display of an electronic device including an event portion in which information pop-ups for each of a plurality of tagged items automatically appear whenever tagged items are present throughout a digital event;

FIGS. 8A and 8B illustrate other example embodiments of a display of an electronic device upon which an end-user may view a digital event;

FIG. 9 shows a simplified diagram of a global positioning system (GPS) locating system;

FIG. 10 is an exemplary embodiment of a close-range positional location system operating via a wireless communications network associated with a facility or otherwise localized geographical area; and

FIG. 11 is a simplified block diagram of a machine in an exemplary form of a computing system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody various aspects of the inventive subject matter described herein. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on selecting items of interest during viewing of a digital event (e.g., a movie), the embodiments are given merely for clarity in disclosure. Thus, any type of electronic commerce or electronic business system and method, including various system architectures, may employ various embodiments of the systems and methods of selecting items and using metadata associated with a digital event to search for inventory, as described herein, and are considered as being within a scope of the inventive subject matter described.

In various embodiments, the inventive subject matter described herein is a system and method to use metadata associated with a digital event to search for inventory of items selected from the digital event. The digital event can be any type of visually-based media viewable on an electronic device. The electronic device may be, for example, a personal computer, a laptop, a notebook, a smart phone, or other electronic device capable of displaying the digital event. The digital event is a dynamic sequence of sequential portions, segments, or frames, and can be, in various exemplary embodiments, a movie, a television program, a documentary, or a video game, for example. Therefore, unlike a single web-page presented to an end-user, the digital event is a dynamic digital event. A skilled artisan will immediately recognize, after reading the various embodiments described herein, that the digital event can be any number of different types of media displayable on the electronic device of an end-user.

Within various segments, portions, or scenes of the digital event, the end-user can, in various embodiments, pause the digital event when the end-user spots an item of interest (“item”). By hovering over the item, or noting a list displayed on the electronic device, the end-user can select one or more of the items to determine additional details associated with the item. The additional details are determined by metadata that previously have been associated with the item. The metadata can include, for example, the manufacturer of the item, the sizes of the item that are available, the types of materials involved in producing the item, the various colors in which the item may be available, and so on. The metadata may also display one or more locations from which the item may be purchased, along with a range of prices.

In various embodiments, the digital event does not need to be paused to select one or more items. The end-user can simply tap on a particular portion of the screen in proximity to an item of interest. The electronic device may then simply record the selections made by the end-user and store the items for later review. The device can then display a listing of the metadata associated with the selected item as described above and, further, suggest a nearby location or on-line site in which to purchase the item (discussed in more detail, below). This process can be performed for each selected and stored item. If the end-user has forgotten how the item appeared visually in a given portion of the digital event, the device can log a timestamp or scene from the digital event. Once selected, the end-user can choose to return to the exact point in the digital event where the item was first selected.

By tracking the location of the electronic device of the end-user, a listing of nearby retailers can be displayed that carry the item. Alternatively or in addition, the electronic device can also display on-line retailers or auctions from which the item can be purchased or, in the case of an auction, upon which a bid may be placed for the item. The tracking of the device may be determined by a global positioning system (GPS) device built into the device. In other embodiments, a location of the device can be determined by, for example, triangulation schemes from nearby cellular phone towers, local-area networks, wide-area networks, or a number of other positioning schemes known independently in the art. A number of selected items within the digital event are encoded with metadata.

In various embodiments, social rating regarding an overall popularity of a selected item can also be displayed to the end-user. The social rating can include, for example, a pop-up chart or other indicator describing or graphically displaying how many other people purchased the selected item or similar items. Alternatively, the social rating can be tied into the end-user's on-line social network and indicate how many friends or relatives purchased the selected item or a similar item.

In various embodiments, the digital event can be synchronized or integrated with calendar events located on or otherwise associated with the electronic device of the end-user. For example, a recommendation can be displayed for one or more items occurring during the digital event. The recommendation can be based on information stored with the metadata. In an example embodiment, the metadata can include a selected age range of interest for the selected item. If a calendar event indicates that the birthday of the end-user's five year old daughter is approaching, viewing a particular scene of the digital event in which the selected items is displayed will trigger a recommendation as being appropriate or preferred by many five year old children. The end-user can select the item, consider the item for later review, or ignore the recommendation.

In still other example embodiments, the end-user can view a “live” event, such as a movie playing at a local theater or a play at a local repertory theater. The electronic device can be synchronized, for example, in time, with the movie or play and items of interest can be selected while viewing the movie or play. The synchronization can occur in a number of ways known independently in the art. For example, a coding of light can be placed at various times within the live event to be “read” by an electronic device of the end-user. The coding can be, in various example embodiments, an infrared code only detectable by electronic devices and not humans present in the theater. In other embodiments, various types of barcodes (such as a quick response (QR) code) can be subtly embedded at various points in the movie. In still other embodiments, an ultrasonic tone can be emitted to synchronize the electronic device with the movie.

The metadata can be embedded in the digital event in a number of ways, discussed in more detail, below. In various embodiments, the metadata can be added to the digital event by a producer of the digital event, such as the studio producing or distributing the movie. In other embodiments, one or more third-parties responsible for product placement within the digital event can each provide metadata associated with their respective products. The various pieces of metadata can then be compiled and incorporated into the digital event prior to release of the digital event. In other embodiments, a combination of these and related methods can be used to produce the metadata.

In an exemplary embodiment, a method, and a related computer-readable medium to perform the method, of selecting and retrieving information related to selectable items in a dynamic digital event (e.g., a movie) is presented. Each of the selectable items is available for purchase by an end-user. The method includes preparing the digital event for presentation on an electronic device of the end-user. Preparing the digital event includes generating tags for each of the selectable items within the digital event and adding metadata for each item. The metadata includes a description for each item. An indication is displayed to the end-user that one or more of the selectable items are present within at least a portion of the digital event. A determination is made whether the end-user has selected at least one selectable item. Based on a determination that the end-user has selected the at least item, the metadata associated with the at least one item is displayed to the end-user.

In another exemplary embodiment, a method of selecting and retrieving information related to a plurality of selectable items in a dynamic digital event is presented. The method includes displaying to an end-user an indication that one or more of the selectable items are present within at least a portion of the digital event. Each of the selectable items has associated metadata and is available for purchase. A determination is made whether the end-user has selected at least one item. Based on the determination that the end-user has selected the at least one item, the metadata associated with the item is displayed to the end-user. A merchant that sells the item is located. Each of these exemplary embodiments, and others, is discussed in detail, below.

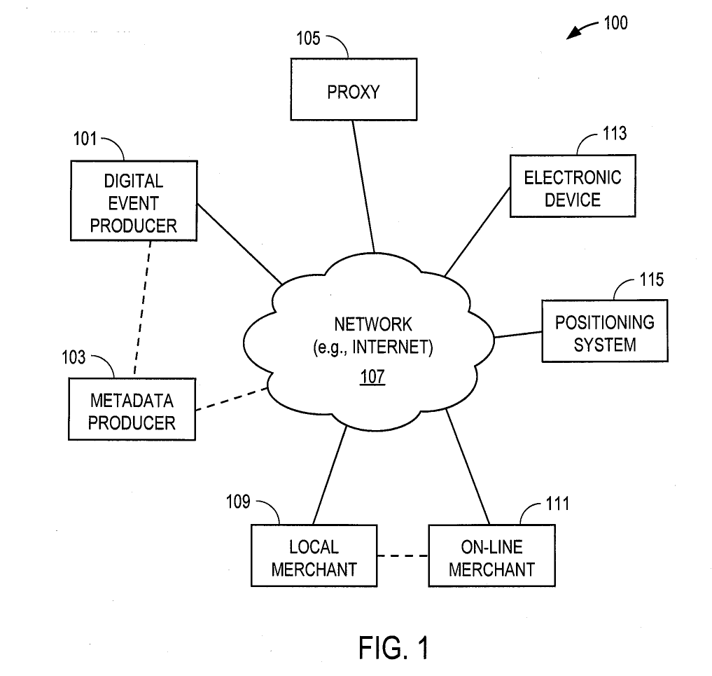

With reference now to FIG. 1, a simplified high-level diagram 100 depicting an environment according to various exemplary embodiments of selecting items and using metadata associated with a digital event to search for inventory is shown. The high-level diagram 100 is shown to include a digital event producer 101, a metadata producer 103, a proxy 105, an electronic device 113 of an end-user, and a positioning system 115. Each of these elements is communicatively coupled to one another through a network 107 (e.g., the Internet).

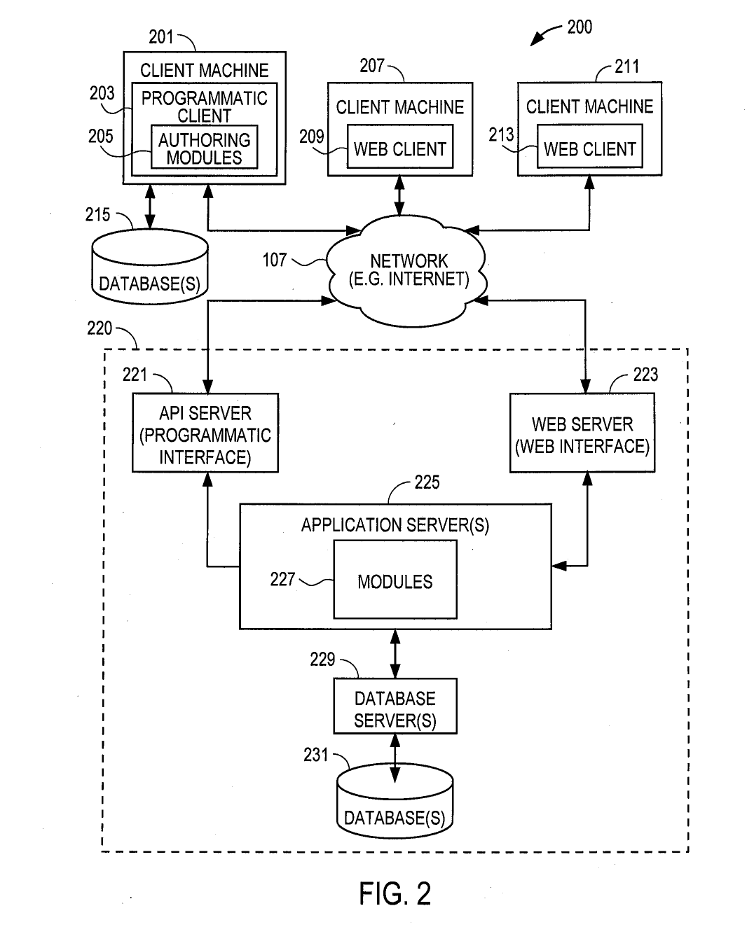

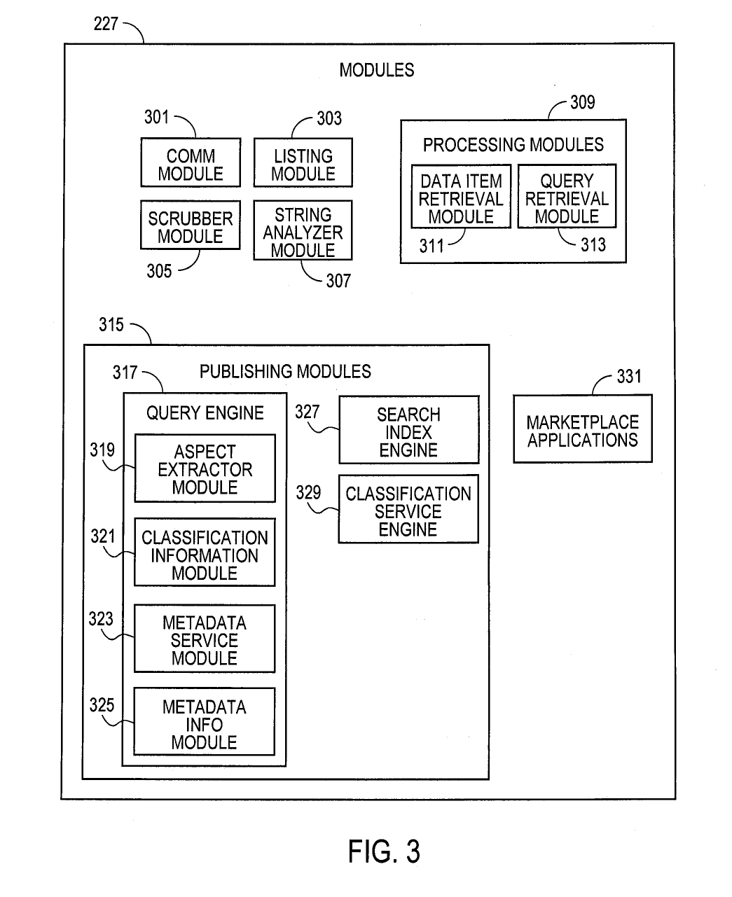

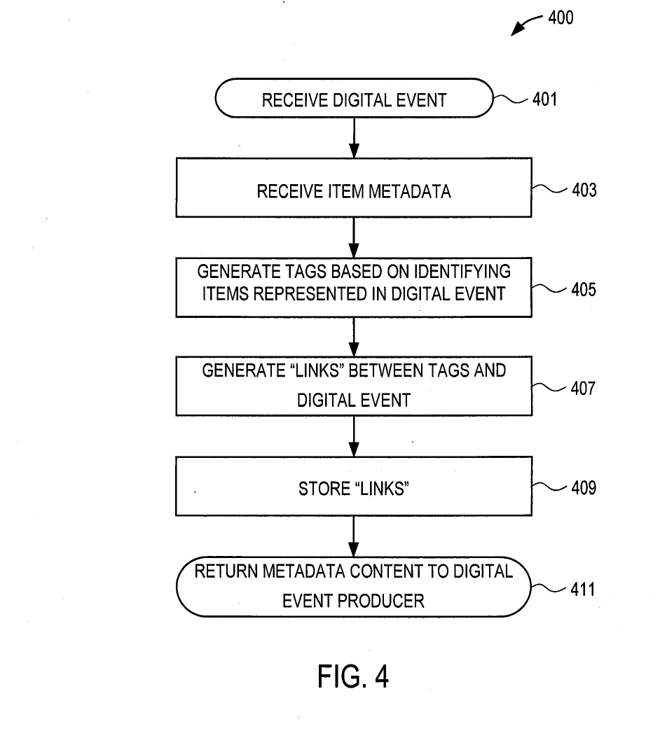

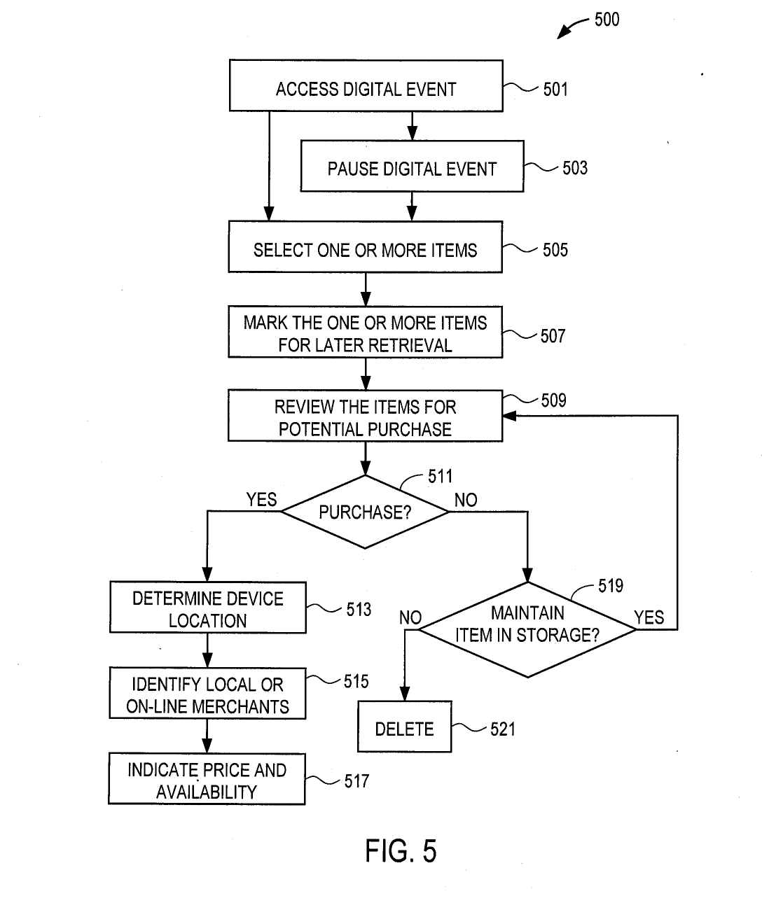

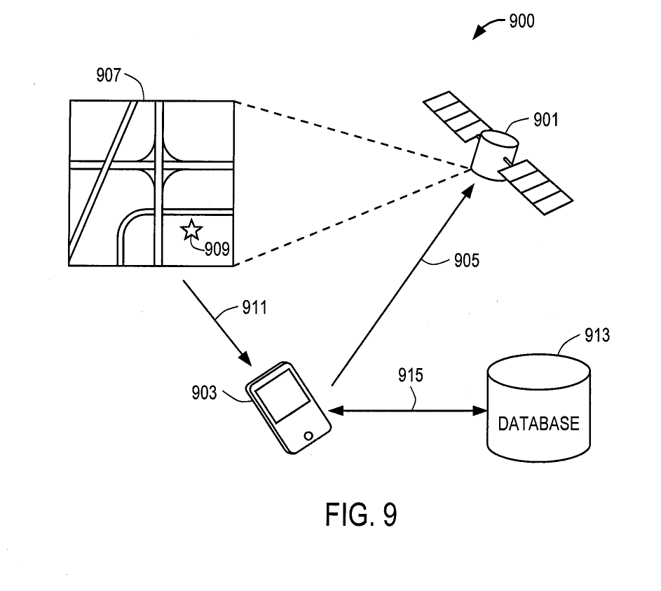

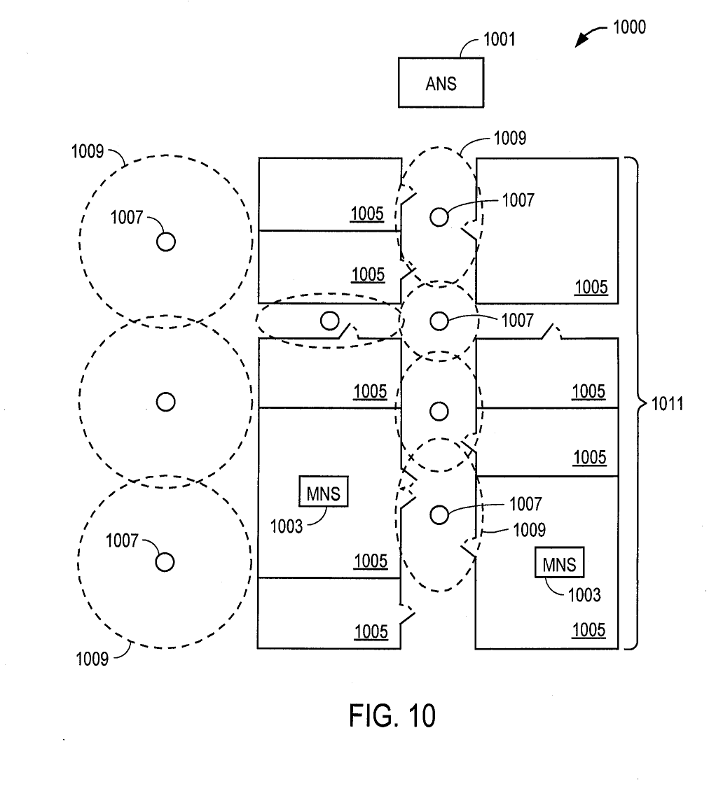

The digital event producer 101 may be, for example, a movie studio producing a feature-length movie. The digital event producer 101 may also be a television studio producing a television series. These and other various types of digital event producer are discussed in more detail herein. The metadata producer 103 is discussed above and will be discussed in more detail with reference to at least FIG. 4, below. The proxy 105 may be any type of, for example, computer network service allowing the end-user to provide indirect network connections to other network services. One type of proxy is discussed with reference to at least FIGS. 2 and 3, below. As discussed above, the electronic device 113 may be, for example, a personal computer, a laptop, a notebook, a smart phone, or other electronic capable of displaying the digital event. Further discussion of the electronic device 113 is provided herein. A selection of one or more items from the digital event is made by the end-user on the electronic device 113 as described by at least FIGS. 5, 6, 7, 8A, and 8B. Once the selection is made, the positioning system 115, described in, for example, FIGS. 9 and 10, locate either a local merchant 109 or an on-line merchant 111, from which the end-user may purchase the selected items. Various embodiments describing these elements are discussed in more detail, below.

With reference to FIG. 2, a high-level network diagram of an exemplary embodiment of a system 200 with a client-server architecture includes a first client machine 201, a second client machine 207, a third client machine 211, a network 107 (e.g., the Internet), and an information storage and retrieval platform 220. Each of the client machines 201, 207, 211 can be considered as an electronic device of the end-user, as described above. In this embodiment, the information storage and retrieval platform 120 constitutes a commerce platform or commerce server and provides server-side functionality, via the network 217, to the first 201, second 207, and third 211 client machines. A programmatic client 203 in the form of authoring modules 205 executes on the first client machine 201. A first web client 209 (e.g., a browser, such as the Internet Explorer browser developed by Microsoft Corporation of Redmond, Wash.) executes on the second client machine 207. A second web client 213 executes on the third client machine 211. Additionally, the first client machine 201 is coupled to one or more databases 215.

Turning to the information storage and retrieval platform 220, an application program interface (API) server 221 and a web server 223 are coupled to, and provide programmatic and web interfaces respectively to, one or more application servers 225. The application servers 225 host one or more modules 227 (e.g., modules, applications, engines, etc.). The application servers 225 are, in turn, coupled to one or more database servers 229 facilitating access to one or more information storage databases 231. The one or more modules 227 provide a number of information storage and retrieval functions and services to users accessing the information storage and retrieval platform 220. The one or more modules 227 are discussed in more detail, below.

While the system 200 of FIG. 2 employs a client-server architecture, a skilled artisan will recognize that the present disclosure is not limited to such an architecture. The system 200 could equally well find application in, for example, a distributed, or peer-to-peer, architecture system. The one or more modules 227 and the authoring modules 205 may also be implemented as standalone software programs, which do not necessarily have networking capabilities.

The first 209 and second 213 web clients access the one or more modules 227 via the web interface supported by the web server 223. Similarly, the programmatic client 203 accesses the various services and functions provided by the one or more modules 227 via the programmatic interface provided by the API server 221. The programmatic client 203 is, for example, a seller application (e.g., the “Turbo Lister 2” application developed by eBay Inc., of San Jose, Calif.) enabling sellers to author and manage data items or listings on the information storage and retrieval platform 220 in an off-line manner. Further, batch-mode communications can be performed between the programmatic client 203 and the information storage and retrieval platform 220. In addition, the programmatic client 203 can include, as previously indicated, the authoring modules 205 used to author, generate, analyze, and publish domain rules and aspect rules. The domain and aspect rules are used in the information storage and retrieval platform 220 to structure the data items and transform queries. Such domain and aspect rules are known independently in the art.

Referring now to FIG. 3, an exemplary block diagram of the one or more modules 227 of FIG. 3 includes a communication module 301, a listing module 303, a scrubber module 305, a string analyzer module 307, a plurality of processing modules 309, and publishing modules 315. The one or modules 227 further includes a marketplace application block 331. Each of these various modules can assist in the storage and searching of metadata for various ones of the selected items from the digital event, discussed above.

The communication module 301 receives a query from one or more of the client machines 201, 207, 211 (see FIG. 2). The query includes one or more constraints (e.g., keywords, categories, or information specific to a type of data item). The communication module 301 interacts with a query engine 317 and a search index engine 327, both located in the publishing module 315, to process the query. In conjunction with the query engine 317 and the search index engine 327, the communication module 301 attempts to extract aspect-value pairs (e.g., brand=“Donna Karan”) based on the query. Details of the aspect-value pairs are described in more detail, below.

The publishing modules 315 publish new or existing rules, as discussed above with reference to FIG. 1, to the information storage and retrieval platform 220, thereby enabling the rules to be operative (e.g., applying the rules to data items and queries). In a specific exemplary embodiment, the information storage and retrieval platform 220 of FIG. 2 may be embodied as a network-based marketplace that supports transactions of data items or listings (e.g., goods or services) between sellers and buyers. One such marketplace is eBay, The World's Online Marketplace®, developed by eBay Inc., of San Jose, Calif. In this embodiment, the information storage and retrieval platform 220 receives information from sellers describing the data items. The data items are subsequently retrieved by potential buyers or bidders. The one or more modules 227 include the marketplace application block 331 to provide a number of marketplace functions and services to end-users accessing the information storage and retrieval platform 220.

The publishing modules 315 further include a classification service engine 329. The classification service engine 329 applies domain rules to identify one or more domain-value pairs (e.g., product type=women's blouses) associated with the data item. The classification service engine 329 further applies the aspect rules to identify aspect-value pairs associated with the data item. The classification service engine 329 applies the domain and aspect rules to data items or listings as they are added to the information storage and retrieval platform 220 or responsive to the publication of new rules (e.g., domain rules or aspect rules). The scrubber module 305 utilizes services of the classification service engine 329 to structure the item information in the data item (e.g., the classification service engine 329 applies domain and aspect rules). The classification service engine 329 then pushes or publishes item search information over a bus (not shown but implicitly understood by a skilled artisan) in real time to the search index engine 327.

The search index engine 327 includes search indexes and data item search information (e.g., including data items and associated domain-value pairs and aspect-value pairs). The search index engine 327 receives the transformed query from the communication module 301 and utilizes the search indexes to identify data items based on the transformed query. The search index engine 327 communicates the found data items to the communication module 301.

A query retrieval module 313, within the plurality of processing modules 309, receives information from one or more of the client machines 201, 207, 211 and stores the information as a data item in the one or more information storage databases 231 (see FIG. 2). For example, an end-user, acting as a seller and operating on one of the client machines, enters descriptive information for the data item to be offered for sale or auction through the information storage and retrieval platform 220.

The plurality of processing modules 309 receives classification information and metadata information associated with the data item. The information is published to, for example, a local backend server (not shown) hosting the query engine 317, the search index engine 327, and the classification service engine 329.

The plurality of processing modules 309 further includes a data item retrieval module 311 to receive requests for data items from a client machine. For example, responsive to receiving a request, the data item retrieval module 311 reads data items from the data item information stored on the one or more information storage databases 231 (FIG. 2) and stores the data items as sample information in the one or more databases 215 for access by the client machine. Responsive to receiving the request, the query retrieval module 313 reads queries from the sample information and communicates the queries to the client machine.

The string analyzer module 307 receives requests from the first client machine 201 to identify candidate values to associate with an aspect. The request may include the aspect and one or more values that have been associated with the aspect. The string analyzer module 307 utilizes the aspect (e.g., “color”) to identify strings of text in a database that includes the aspect. The string analyzer module 307 relies on various services provided in the information storage and retrieval platform 220 to identify and process the strings of text. For example, the string analyzer module 307 utilizes services that expand the aspect to a derivative form of the aspect including a singular form (e.g., “color”), a plural form (e.g., “colors”), a synonymous form, an alternate word form (e.g., “chroma,” “coloring,” or “tint”), a commonly misspelled form (e.g., “collor”), or an acronym form.

A database (not shown specifically) used by the string analyzer module 307 includes queries or data items that have been entered by an end-user (e.g., buyer or seller, respectively although a seller may wish to enter queries as well) to the information storage and retrieval platform 220. The database can also store or reference dictionaries, thesauruses, or other reference sources. The string analyzer module 307 analyzes the strings of text to identify candidate values to associate with the aspect. More examples of query strings and searching techniques are given, below.

The query engine 317 includes an aspect extractor module 319, a classification information module 321, a metadata service module 323, and a metadata information module 325. The aspect extractor module 319 receives a query from the communication module 301 and applies aspect rules to extract aspect-value pairs from the query. Further, the aspect extractor module 319 communicates the query received from the communication module 301 to the plurality of processing modules 309 that stores the query as sample query information.

The classification information module 321 includes phrases from a plurality of past searches to reference against the query. For example, synonyms or related information for a query can be stored in the classification information module 321 to aid an end-user in locating an item or a particular set of items.

The metadata service module 323 communicates descriptive metadata information to the communication module 301 based on a query received from the communication module 301. The metadata information is retrieved from the metadata information module 325 and includes metadata that the communication module 301 uses to format and generate an end-user interface to provide additional information to the end-user based on the original end-user-generated query.

Once aspect-value pairs, classification information, and other relevant information is retrieved through, for example, either the data item retrieval module 311 or the query retrieval module 313, the listing module 303 provides additional assistance to an end-user listing the data item. The additional assistance can be, for example, one or more interfaces for the end-user to upload photographs, textual descriptions, and bidding information.

Although the one or more modules have been defined in terms of a variety of individual modules and engines, a skilled artisan will recognize that many of the items can be combined or organized in other ways. The description given herein simply provides an exemplary embodiment to aid the reader in an understanding of the systems and methods used herein.

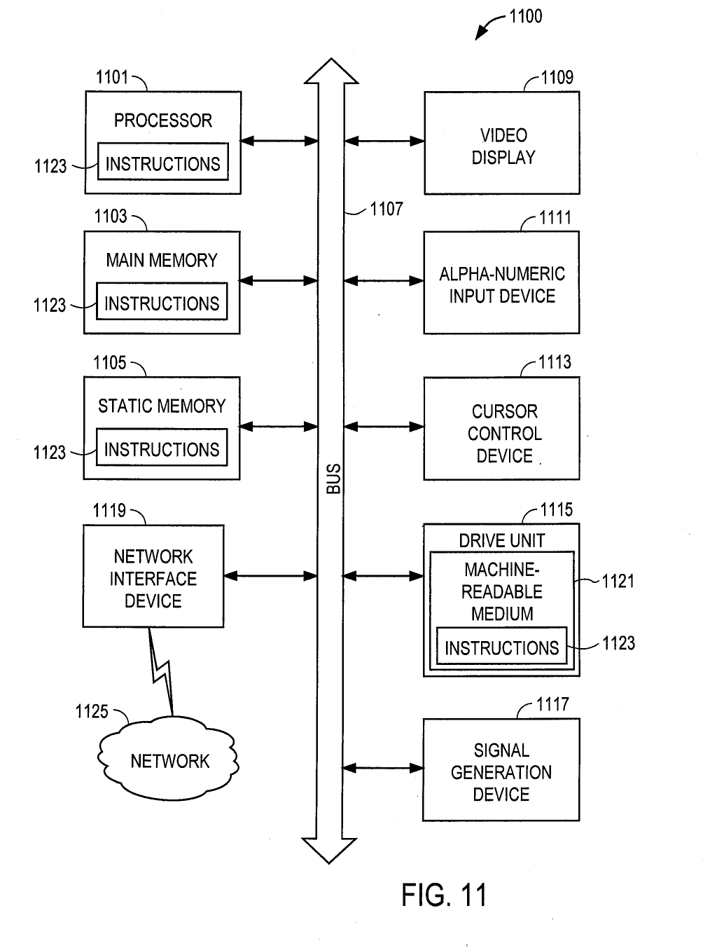

FIG. 4 shows an exemplary method 400 of inserting or storing metadata associated with items into a digital event. Various implementations of, or processing in, the exemplary method 400 may be performed by software (e.g., instructions or code modules) when executed by one or more processors. Additionally, the various implementations may be accomplished by hardware components of an electronic device or application-specific integrated circuits, or by combinations of software and hardware elements. Such implementation and interactions are discussed in more detail with reference to at least FIG. 11, below. As discussed above, various entities can produce the metadata. For example, the digital event producer 101 and the metadata producer 103 of FIG. 1 may be different divisions within the same entity such as, for example, a movie studio. In other embodiments, the metadata producer 103 can be one or more third party entities including manufacturers of the various items displayed within the digital event.

With continued reference to FIG. 4, at operation 401, the digital event is received. For the exemplary method 400 described, the digital event can be assumed to be a movie received from a movie studio. Of course, a skilled artisan can readily apply the various operations to any type of digital event based on the discussions provided herein. At operation 403, the metadata for one or more of the items in the digital event are received. As discussed above, the metadata may include size, color, related items, price, and other information related to each item. The metadata can also include embedded links to distributors (that can be used to search for local merchants), on-line merchants, and other related information.

At operation 405 tags are generated based on identifying items represented within the digital event. In general, a tag may identify all or part of the content or an object represented in the content, such as, for example, an item, person, product, service, phrase, song, tune, place, location, or building and so on, within the digital event. The tag may have an identifier than can be used to look up information about the tag and a corresponding object represented in the content. In some embodiments, the tag may further identify the location of the item within all or part of the content.

At operation 407, one or more “links” between the one or more tags and tag associated information (TAI) are generated. A link can include one or more relationships between a tag and TAI. In various embodiments, a link may include or be represented by one or more static relationships, in that an association between a tag and the TAI never changes or changes infrequently. For example, one static relationship is an identifier of a particular item, and a location of the item, in a scene during the movie. In various embodiments, the one or more links between the one or more tags and the TAI may have dynamic relationships. The TAI to which a tag may be associated may change based on the region of the world, or region of a country, in which the end-user is viewing the digital event. A determination of location of the end-user is described in more detail, below, especially with reference to FIGS. 9 and 10. Accordingly, the one or more links can be dynamically added, activated, deactivated, removed, or modified, remotely or locally, at any time and for a variety of reasons.

At operation 409, the links are stored and access is provided to the links. For example, information representing the links may be uploaded and stored in the information storage databases 231 of FIG. 2. In other embodiments, the links are coded into the digital event directly. In various embodiments, all of the information relating to the metadata is simply returned to the digital event producer 101 (FIG. 1) and the digital event producer 101 makes a determination where to store the links. At operation 409, all metadata content is returned to the digital event producer.

As briefly described above, in various embodiments, the items may be initially tagged and metadata added by the same group that created the digital event (e.g., a movie or television production studio). The items may be tagged prior or subsequent to distribution to consumers. As known independently in the art, one or more types of tagging tools can be developed and provided to professional content creators to provide accurate and easy ways to tag content. As noted, in various embodiments, the items can be tagged by third parties, whether or not affiliated with the digital event producer. For example, movie production studios may outsource the tagging of content and items to contractors or other organizations and companies. In other embodiments, a purchaser or end-user of the digital event may create and associate tags and metadata with the various items contained within the digital event. Purchasers or end-users of the digital events may add metadata and tags associated with the various items and may be members of social networking sites, members of fan communities, bloggers, members of the media, or the like.

Regardless of how added to the digital event, the metadata and tags associated with the digital event can be added, activated, deactivated, or removed at will. For example, metadata and tags can be added to the digital event after delivery to consumers (by, for example, downloads to the end-user). In various embodiments, the metadata and tags associated with the digital event can be turned on (activated) or turned off (deactivated) based on end-user settings, item producer requirements, regional restrictions or locale settings, location, cultural preferences, age restrictions, or the like. In various embodiments, the metadata and tags associated with the digital event can be turned on (activated) or turned off (deactivated) based on business criteria, such as whether the end-user (e.g., a subscriber) has paid for access to metadata and tags associated with the digital event, whether a predetermined time period has expired, whether an advertiser has discontinued sponsorship or manufacture of an item, or the like.

Referring now to FIG. 5, an exemplary method 500 of selecting items during a digital event is shown. The digital event may be streamed, downloaded, inserted (e.g., in the form of a DVD or Blu-Ray Disc®), or broadcast to the electronic device 113 (FIG. 1). As noted above, included within the digital event are placed a variety of products or services with associated tags and metadata.

The exemplary method 500 begins at operation 501 where the end-user accesses and begins playback of a digital event. In various embodiments, the end-user may be alerted to the presence of one or more items by a single icon or other visual representation appearing on the electronic device 113 (FIG. 1) to provide an indication that at least one item is selectable in the scene. In various embodiments, several icons may appear on the electronic device 113 in an area outside of the displayed content for each selectable element. In various embodiments, a list or listing of items may be provided in an area outside of the displayed digital event. When the end-user either sees or is alerted that one or more selectable items may be present in which the end-user has an interest, the end-user has at least two options. At operation 503, the end-user may pause the digital event prior to making a selection. Alternatively, the end-user may simply select one or more items, at operation 505, “on the fly” (i.e., without pausing the digital event). The end-user may make a selection by tapping, using a pointing device (e.g., a mouse or joystick), or otherwise affirmatively making an indication on the electronic device 113.

The end-user may then mark the one or more items for later review at operation 507. Once marked, the end-user may review the items in more detail (e.g., by viewing the associated metadata for the one or more selected items). For example, the end-user may review the items for potential purchase at operation 509. As is understood by this point in the discussion of the exemplary method 500, a skilled artisan will appreciate that many of the operations described may be performed in alternate arrangements or sequences. For example, operation 509, and one or more subsequent operations, may be reviewed after a complete viewing of the digital event.

At operation 511, a determination is made by the end-user in response to a query from the electronic device 113 whether to purchase one or more of the selected items. If the end-user chooses not to purchase the item immediately, another determination is made by the end-user, in response to a second query, whether to maintain the item in storage, at operation 519. If the end-user chooses not to maintain the item in storage, the item is deleted at operation 521. If the end-user chooses to maintain the item in storage for later review, the end-user is given the opportunity to later review the item again at operation 509.

Referring again to operation 511, if the end-user chooses to purchase at least one of the selected items, the location of the electronic device 113 of the end-user is determined at operation 513. The electronic device 113 may be located by, for example, GPS location positioning, local area network location positioning, or cellular signal triangulation. More detail about determining the location of the device is given, below, with reference to FIGS. 9 and 10.

At operation 515, a local or on-line merchant is identified that may have the item in inventory. Operation 515 is discussed in more detail in connection with FIG. 9 below. At operation 517, the availability and the price of the item are indicated to the end-user, as discussed elsewhere herein. As noted above, various operations can be displayed or performed in sequences other than the ones shown. Also, various ones of the operations may be combined into a single operation. For example, the price and availability information of operation 517 may be combined with the review items query at operation 509. More details are provided herein for various operations described with reference to the exemplary method of FIG. 5.

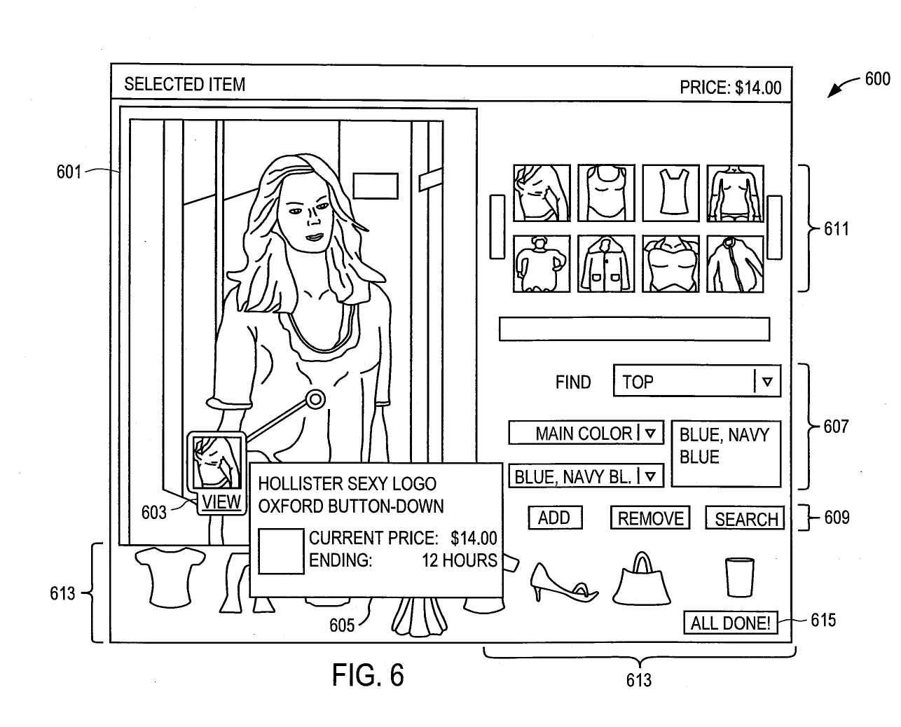

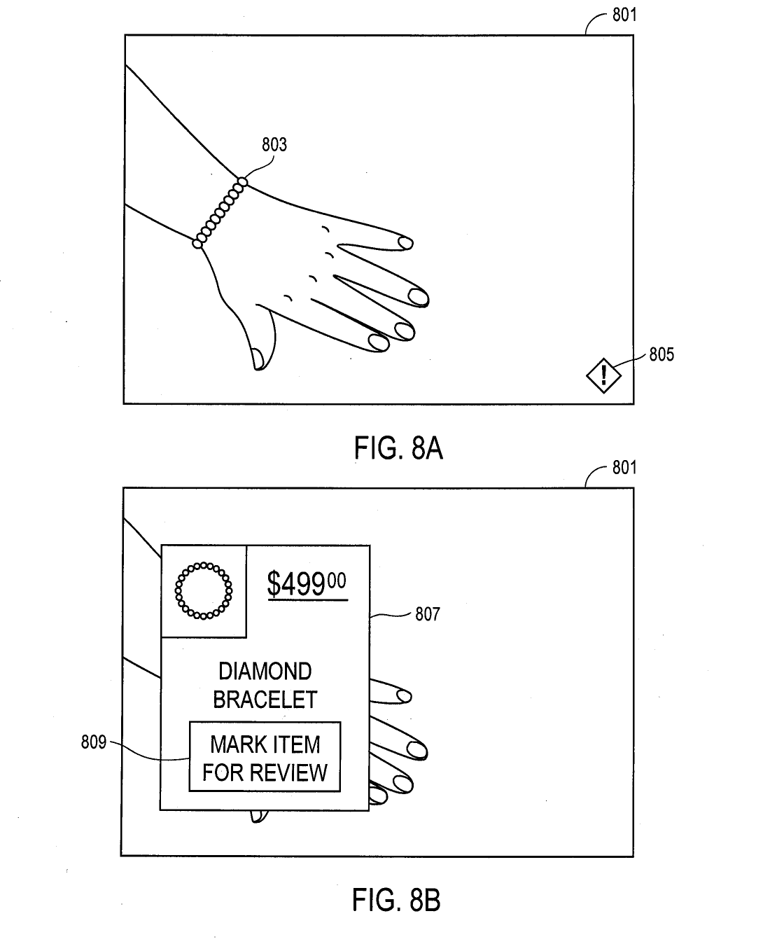

With reference now to FIG. 6, an example embodiment for a display 600 of the electronic device 113 (FIG. 1) of the end-user illustrates various pop-up menus that can occur during the viewing of a digital event. In this example embodiment, the display 600 may be an entire portion of a smart phone or a window in a laptop computer. An actress in an event portion 601 of the display 600 is wearing one of a plurality of tagged items as noted within the event portion 601. The end-user is alerted that the event portion 601 contains one or more of the plurality of tagged items. The alert can be in the form of, for example, a small pop-up (not shown explicitly in FIG. 6 but described with reference to FIGS. 8A and 8B, below) that occurs in a given portion of the display 600, such as in the lower right hand corner. The alert can also be in the form of a brief flash of light or an auditory signal, such as a small beep.

If the end-user sees an item of interest in the event portion 601, the end-user may pause the digital event or simply move a cursor to temporarily hover over the item of interest. For each of the plurality of tagged items in the event portion 601, a pop-up information window 603 appears providing more information relating to the selected item for the end-user. Alternatively or in addition to the pop-up information window 603, an additional pop-up window 605 with more detailed information, and one or more information screens 613 may also appear, either beside the event portion 601, or covering a portion of the event portion 601. The one or more information screens 613 can include a variety of other information areas including, for example, a find item block 607 and a selection block 609. The end-user can use the find item block 607 to locate related or similar items to that shown in the pop-up information window 603. Additionally, the end-user can enter additional information, such as color or colors, in the find item block 607. The related or similar items can be automatically searched, based on the stored metadata for the selected item, by the query engine 317 of the retrieval platform 220 (see FIG. 3). An image result block 611, based on the automatically-entered search criteria, displays retrieved items in a grid-like format. The end-user may then select the original item of interest, displayed by the pop-up information window 603, or select individual items from the image result block 611. The end-user may then iteratively add or removes items by additional searches and selecting the add or remove buttons from the selection block 609. The selected items may then be saved for further review.

Once the end-user has completed selections, the end-user may tap the “All Done!” button 615, or simply hit play to resume the digital event. A local or on-line merchant can then be determined immediately, as discussed above, or the item data stored and later determined.

In a specific exemplary embodiment, each of the various pop-up windows and menus can be implemented in, for example, Flex, an Adobe® Flash® product. However, many other software packages are known independently in the art to implement the various items of the displays.

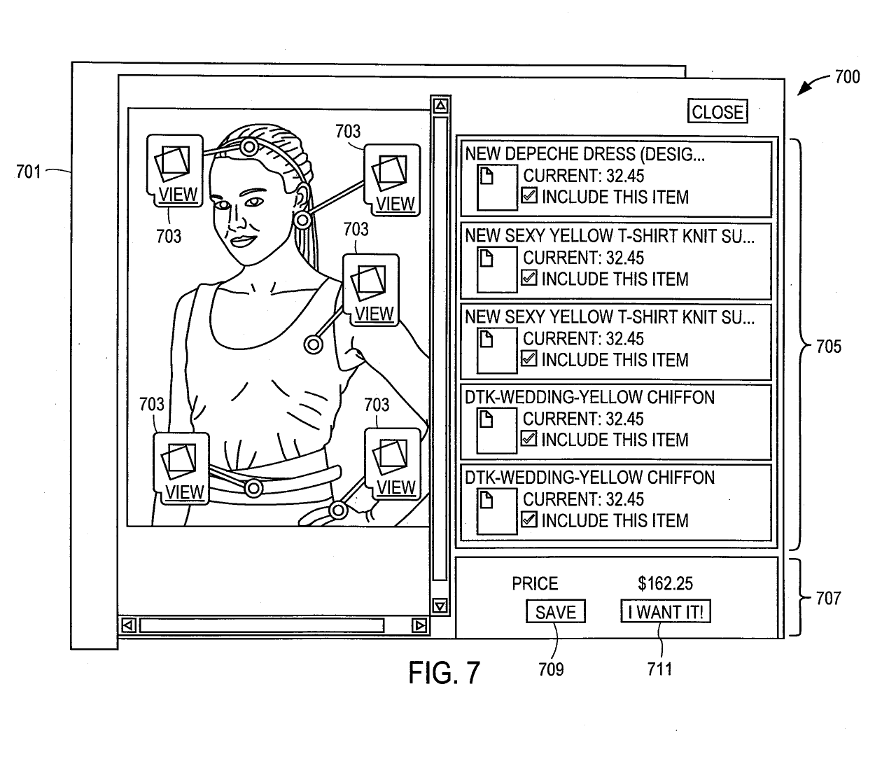

With reference to FIG. 7, in an alternative embodiment, a display 700 of the electronic device 113 (FIG. 1) of the end-user, includes an event portion 701 in which information pop-ups 703 for each of the tagged items automatically appear whenever tagged items are present throughout the digital event. The information pop-ups 703 can be reduced in transparency level (e.g., to 10%) so as to be barely discernible through the digital event. In this case, the image of an actress includes a plurality of tagged items including a headband, earrings, a dress, a belt, and a ring. Each of the plurality of tagged items can be selected by choosing (e.g., by clicking or tapping on the display 700) one or more of the information pop-ups 703. Once chosen, a textual description and current price or bid appear within a side bar 705.

Metadata for each of the plurality of tagged items may be originally entered into as described, above, with reference to at least FIG. 4. The end-user can select any of the plurality of tagged items by selecting each desired item through the textual description of the side bar 705. Alternatively, the end-user is presented with a total price block 707 and can purchase all items shown by selecting the “I want it!” button 711 within the total price block 707. If the end-user selects the “I want it!” button 711, a determination is made of a local or on-line merchant, as discussed above. Alternatively, the end-user can save the one or more selected items for later review by selecting the “Save” button 709.

FIGS. 8A and 8B illustrate other example embodiments of a display 801 of the electronic device 113 (FIG. 1) upon which the end-user may view a digital event. Unlike FIGS. 6 and 7 that included separate event portions of the display, the entirety of the display 801 of FIGS. 8A and 8B is dedicated to viewing a digital event. In other embodiments, not shown, the display 801 may have a smaller event portion (not shown explicitly). The display 801 of FIG. 8A is shown to include an item of interest 803, a diamond bracelet, and a tagged item indicator 805. When any tagged item appears during viewing of the digital event, the tagged item indicator 805 automatically appears on the display. The tagged item indicator 805 signals to the end-user that one or more tagged items are available for viewing within the display 801. The end-user viewing the digital event may desire to obtain more information about the item of interest 803. The end-user can activate the tagged item indicator 805 to receive more information about the item of interest 803.

In an alternative to activating the tagged item indicator 805 to receive more information about the item of interest 803, the end-user may choose to search for the tagged items in the display by, for example, clicking or tapping the tagged item indicator 805, thus displaying all tagged items within the display 801, or pausing the digital event and hovering over various parts of the display until the tagged items appear. In FIG. 8B, the end-user hovered over or otherwise “found” the tagged item. A brief information panel 807 (or pop-up window) appears displaying additional information about the tagged item. The end-user may then select the “Mark Item for Review” button 809 to later review the item, be directed to a local or on-line merchant, or consider purchase of the item. The brief information panel 807 may be presented as a picture-in-picture window over the original digital event. Alternatively, the brief information panel 807 may simply be displayed as a reduced opacity box that allows the end-user to continue to see the item of interest 803 through the brief information panel 807.

As noted above, the tagged item indicator 805 may be placed in some or all of those frames, portions, or segments of the digital event which include an item that is available for purchase. The tagged item indicator 805 alerts the end-user that an item shown on the display 801 is available for purchase. Alternatively, the tagged item indicator 805 may be visibly present throughout the digital event, but is highlighted (e.g., by color, brightness, flashing, or otherwise) during those portions of the digital event when one or more items available for purchase are visibly displayed in the digital event.

In various embodiments, an additional feature of the inventive subject matter may include automatically activating a pause feature when the end-user enters a command to obtain more information or purchase an item displayed in the digital event. Upon completion and exiting of, for example, the brief information panel 807, the pause is released or a prompt is provided to the end-user to release the pause.

FIG. 9 shows a simplified diagram of a GPS locating system 900. The GPS locating system 900 is shown to include a GPS satellite 901, a smart phone 903, and a merchant database 913. The smart phone 903 may be the electronic device 113 discussed with reference to FIG. 1. The merchant database 913 may be a local database maintained by an area chamber of commerce, the information storage databases 231 discussed above (see FIG. 2), or a merchant database 913 such as Website Yellow Pages®, maintained by Platinum Advertising LLC of Appleton, Wis., USA.

In various ones of the example embodiments discussed, the end-user of the electronic device 113 is either automatically directed to, or given the option of being directed to, a local merchant to view or purchase the selected items of interest. The GPS locating system 900 can be used to make a determination of the local merchant. The GPS satellite 901 tracks the smart phone 903 by an integrated circuit (i.e., a GPS receiver) embedded into most cellular phones for the past several years. By means know independently in the art, a signal is received by the GPS satellite 901 from the smart phone 903. (The signal may be received indirectly through a cellular phone tower.) The GPS satellite 901 then determines a location of the smart phone 903 as indicated on a virtual map 907. Within several meters of accuracy, a position 909 of the smart phone 903 is indicated on the virtual map 907 and transmitted or otherwise transferred to the smart phone 903 through a return transmission path 911. The smart phone 903 then transmits the position 909 to the merchant database 913 through a bi-directional communication channel 915. A determination of nearest local merchants can then be determined (by, for example, either the smart phone 903 of the merchant database 913).

In other example embodiments, a determination of position may be made by other means. For example, if the end-user is located within a shopping mall, various networks within the mall may be accessed to determine a location of the electronic device 113 of the end-user.

Referring to FIG. 10, an exemplary embodiment of a close-range positional location system 1000 operating via a wireless communications network associated with a facility 1011 (e.g., a shopping mall, a stadium, an entertainment arena, a theater, etc.) or otherwise localized geographical area. The close-range positional location system 1000 may be used in conjunction with the GPS locating system 900 of FIG. 9, or, optionally, operate separately, to identify a position of the electronic device 113 of FIG. 1. The close-range positional location system 1000 is shown to include an area networking system (ANS) 1001, one or more merchant networking systems (WINS) 1003, a plurality of merchant stores 1005 within the facility 1011, and a plurality of network access points 1007. The ANS 1001 and the MNS 1003 can be, for example, any of various types of wireless local area networks (WLANs). The ANS 1001 and the MNS 1003 can be used in conjunction with one another or separately to determine a position of the electronic device 113 as discussed in more detail, below. The network access points 1007 facilitate wireless communication between the ANS 1001 and the MNS 1003. Connections between the ANS 1001 and the MNS 1003 may be wireless or hardwired via, for example, an Ethernet connection. Each of the network access points 1007 has a limited area of coverage as shown by an associated communication range 1009.

In an example embodiment, when the end-user enters the facility 1011 with the electronic device 113, the ANS 1001 determines a location data of the electronic device 113. The ANS 1001 or the MNS 1003 can determine the location (e.g., relative location) of the electronic device 113 by making a determination which of the network access points 1007 through which the electronic device 113 is either communicating or is accessible by either the ANS 1001 or the MNS 1003. Each of the network access points 1007 has a separate network address. Any data received from the electronic device 113 and received by either the ANS 1001 or the MNS 1003 is determined by the ANS 1001 or the MNS 1003 to have come from a particular one of the network access points 1007. Consequently, by determining which of network access points 1007 has received data from the electronic device 113, and the associated communication range 1009 for that particular access point, either the ANS 1001 or the WINS 1003 can determine the approximate position of the end-user in the facility 1011. Additionally, as a progressive sequence of the network access points 1007 receive data from the electronic device 113, either the ANS 1001 or the MNS 1003 can determine a plurality of locations for the end-user and use the locations to find the nearest local merchant associated with a selected item as discussed. The ANS 1001 and the MNS 1003 may each maintain a database, discussed above, pertaining to information and merchants associated with the selected item. Location information determined by either the ANS 1001 or the MNS 1003 can also be coupled with the GPS determination discussed above with reference to FIG. 9.

Although the “items” discussed herein are generally described in terms of a tangible good, the items can also be considered in terms of services. For example, when the end-user hovers over a scene of one person receiving a massage, the inventive subject matter described recognizes that a message is the item of interest and the process proceeds to find a local merchant that provides this service. Thus, a skilled artisan will recognize that the “items” may be used to describe goods or services.

Additionally, various embodiments discussed herein may be combined, or elements selectively chosen to be adapted into a new embodiment. Thus, many more permutations are possible beyond those explicitly discussed.

Therefore, while various embodiments of the inventive subject matter are described with reference to assorted implementations and exploitations, it will be understood that these embodiments are illustrative only and that a scope of the inventive subject matter is not limited merely to those described embodiments. Moreover, the item selection systems and methods described herein may be implemented with facilities consistent with any hardware system or hardware systems either defined herein or known independently in the art using techniques described herein. Many variations, modifications, additions, and improvements are therefore possible.

### Modules, Components, and Logic

Additionally, certain embodiments described herein may be implemented as logic or a number of modules, components, or mechanisms. A module, logic, component, or mechanism (collectively referred to as a “module”) may be a tangible unit capable of performing certain operations and is configured or arranged in a certain manner. In certain exemplary embodiments, one or more computer systems (e.g., a standalone, client, or server computer system) or one or more components of a computer system (e.g., a processor or one or more processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by cost and time considerations.

Accordingly, the term module should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and

### Machine-Readable Storage Medium

With reference to FIG. 11, an exemplary embodiment extends to a machine in the exemplary form of a computer system 1100 within which instructions, for causing the machine to perform any one or more of the methodologies discussed herein, may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processor 1101 (e.g., a central processing unit (CPU), a graphics processing unit (GPU) or both), a main memory 1103 and a static memory 1105, which communicate with each other via a bus 1107. The computer system 1100 may further include a video display unit 1109 (e.g., a liquid crystal display (LCD) or a cathode ray tube (CRT)). The computer system 1100 also includes an alphanumeric input device 1111 (e.g., a keyboard), a user interface (UI) navigation device 1113 (e.g., a mouse), a disk drive unit 1115, a signal generation device 1117 (e.g., a speaker), and a network interface device 1119.

### Machine-Readable Medium

The disk drive unit 1115 includes a non-transitory machine-readable medium 1121 on which is stored one or more sets of instructions and data structures (e.g., software 1123) embodying or used by any one or more of the methodologies or functions described herein. The software 1123 may also reside, completely or at least partially, within the main memory 1103 or within the processor 1101 during execution thereof by the computer system 1100; the main memory 1103 and the processor 1101 also constituting machine-readable media.

While the non-transitory machine-readable medium 1121 is shown in an exemplary embodiment to be a single medium, the term “non-transitory machine-readable medium” may include a single medium or multiple media (e.g., a centralized or distributed database, or associated caches and servers) that store the one or more instructions. The term “non-transitory machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures used by or associated with such instructions. The term “non-transitory machine-readable medium” shall accordingly be taken to include, but not be limited to, solid-state memories, and optical and magnetic media. Specific examples of non-transitory machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software 1123 may further be transmitted or received over a communications network 1125 using a transmission medium via the network interface device 1119 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of the inventive subject matter as represented by the appended claims. The specification and drawings are, accordingly, to be regarded in an illustrative rather than a restrictive sense.

What is claimed is:

1. A method of selecting and retrieving information related to a plurality of selectable items in a dynamic digital event, the method comprising:
preparing the dynamic digital event for presentation on an electronic device of an end-user, the preparing of the dynamic digital event including:
generating tags for each of the plurality of selectable items within the dynamic digital event, the plurality of selectable items being available for purchase; and
adding metadata for each of the plurality of selectable items, the metadata including a description for each of the plurality of selectable items;
displaying an indication on the electronic device of the end-user that one or more of the plurality of selectable items are present within at least a portion of the dynamic digital event;
making a determination whether the end-user has selected at least one item of the plurality of selectable items; and
based on the determination that the end-user has selected the at least one item, displaying the metadata associated with the at least one item on the electronic device of the end-user.

2. The method of claim 1, further comprising marking and storing the at least one item for later retrieval by the end-user.

3. The method of claim 1, further comprising querying the end-user whether the end-user desires to purchase the at least one item.

4. The method of claim 1, further comprising determining a location of the electronic device of the end-user.

5. The method of claim 4, wherein the location of the electronic device is determined based on a global positioning system.

6. The method of claim 4, wherein the location of the electronic device is determined based on a close-range positional location system.

7. The method of claim 1, further comprising locating a merchant that sells the at least one item, the merchant being local to the electronic device of the end-user.

8. The method of claim 1, further comprising locating a merchant that sells the at least one item, the merchant being accessible on-line.

9. The method of claim 1, further comprising displaying, on the electronic device, a price of the at least one item.

10. The method of claim 1, further comprising displaying, on the electronic device, an availability in inventory of a merchant of the at least one item.

11. A method of selecting and retrieving information related to a plurality of selectable items in a dynamic digital event, the method comprising:
displaying an indication on an electronic device of an end-user that one or more of the plurality of selectable items are present within at least a portion of the dynamic digital event, each of the one or more of the plurality of selectable items having associated metadata, each of the plurality of selectable items being available for purchase;
making a determination whether the end-user has selected at least one item of the plurality of selectable items;
based on the determination that the end-user has selected the at least one item, displaying the metadata associated with the at least one item on the electronic device of the end-user; and
locating a merchant that sells the at least one item.

12. The method of claim 11, further comprising querying the end-user whether the end-user desires to purchase the at least one item.

13. The method of claim 11, further comprising determining a location of the electronic device of the end-user.

14. The method of claim 11, wherein the merchant is local to the electronic device of the end-user.

15. The method of claim 11, wherein the merchant is accessible on-line.

16. The method of claim 11, further comprising displaying, on the electronic device, a price of the at least one item.

17. The method of claim 11, further comprising displaying, on the electronic device, an availability in inventory of the merchant of the at least one item.

18. A non-transitory computer-readable storage medium storing instructions that, when executed by one or more processors, cause the one or more processors to perform an operation, the operation comprising:
preparing a dynamic digital event for presentation on an electronic device of an end-user, the preparing of the dynamic digital event including:
generating tags for each of a plurality of selectable items within the dynamic digital event; and
adding metadata for each of the plurality of selectable items, the metadata including a description for each of the plurality of selectable items, the plurality of selectable items being available for purchase;
displaying an indication on the electronic device of the end-user that one or more of the plurality of selectable items are present within at least a portion of the dynamic digital event;
making a determination whether the end-user has selected at least one item of the plurality of selectable items; and
based on the determination that the end-user has selected the at least one item, displaying the metadata associated with the at least one item on the electronic device of the end-user.

19. The non-transitory computer-readable storage medium of claim 18, further comprising locating a merchant that sells the at least one item.

20. The non-transitory computer-readable storage medium of claim 18, further comprising displaying, on the electronic device, a price and availability in inventory of a merchant of the at least one item.
